(19) United States
(12) Patent Application Publication
(10) Pub. No.: US 2021/0381968 A1
(43) Pub. Date: Dec. 9, 2021

(54) INTERFEROMETRIC SCATTERING MICROSCOPY

(71) Applicants: KOREA UNIVERSITY RESEARCH AND BUSINESS FOUNDATION, Seoul (KR); INSTITUTE FOR BASIC SCIENCE, Daejeon (KR)

(72) Inventors: Seok-Cheol HONG, Seoul (KR); Il Boem LEE, Seoul (KR); Minhaeng CHO, Seoul (KR); Hyeonmin MOON, Seoul (KR); Jin-Sung PARK, Seoul (KR)

(21) Appl. No.: 17/340,696

(22) Filed: Jun. 7, 2021

(30) Foreign Application Priority Data
Jun. 5, 2020 (KR) 10-2020-0068565
Jun. 4, 2021 (KR) 10-2021-0072771

(51) Int. Cl. G01N 21/47; G02B 21/06; G02B 21/04; G02B 27/28

(52) U.S. Cl. CPC G01N 21/47; G02B 21/06; G01N 2021/4792; G02B 27/283; G02B 21/04

(57) ABSTRACT

Disclosed is an interferometric scattering microscope. The interferometric scattering microscope includes a remote refocusing system adapted to reproduce light collected by a high numerical aperture objective lens using another objective lens and thus can acquire an image of an object in a sample without vertical movement of the objective lens or the sample.

### BACKGROUND OF THE INVENTION

### 1. Field of the Invention

The present invention relates to an interferometric scattering microscope.

### 2. Description of the Related Art

Interferometric scattering microscopy (iSCAT) is a microscopic method that detects and images a subwavelength object through optical interference. Optical interference is a phenomenon resulting from superposition of two or more light waves having different phases and either constructive or destructive interference occurs depending on phase difference between the waves. Interferometric scattering microscopy enables detection of an object having a size of several to dozens of nanometers based on interference between light scattered by the object and light reflected by a surface of a sample holder on which the object is placed (that is, an interface between the sample holder and the object). In particular, interferometric scattering microscopy enables detection and imaging of proteins at a single-molecule level and enables measurement of a molecular mass of a target protein based on optical intensity of observed interference/scattering fields.

The smallest object size observable with a conventional bright-field microscope is limited by a diffraction limit. With development of fluorescence technology, it becomes possible to obtain images beyond the limit of optical resolution, which is called super-resolution fluorescence microscopy. However, limited observation time, optical signal saturation due to excessive labelling, and damage to biological samples due to phototoxicity still remain to be solved in the field of fluorescence technology. In this respect, interferometric scattering microscopy can overcome limitations of fluorescence microscopy due to capability of high-sensitivity label-free observation. In addition, interferometric scattering microscopy is a technology with great potential due to capability of intuitive observation of small objects in the Rayleigh scattering area and high-speed imaging.

Light constituting an image of an observation target (object) acquired by interferometric scattering microscopy is classified into a reference part, a scattering part, and an interference part. Here, the reference part is from the light reflected by an interface between a sample in which an observation target is dispersed and a glass substrate or the like on which the sample is placed, the scattering part is from the light scattered by the observation target, and the interference part is generated through interference between these two types of light. Intensity of the interference part changes in proportion to a scattering cross-section of the observation target and is greatly influenced by constructive or destructive interference depending on phase difference between the two types of light. The phase difference is influenced by a distance between a bottom of the sample and the observation target, and modulation of the interference part occurs depending on the phase difference. In addition, when the observation target is out of a focal plane of an objective lens, it is impossible to acquire a focused image of the observation target due to reduction in amount of light collected by the objective lens.

In general optical microscopy, a focused image of an observation target is acquired by moving an objective lens or a sample stage in a vertical direction. However, in interferometric scattering microscopy, changing the focal plane results in change in reference field, making it difficult to extract scattering signals from measurement. As a result, the depth of a vertical space in which the interference/scattering signals corresponding to the object are imaged is limited by the depth of focus of an objective lens of a microscope. Accordingly, acquisition of the interference/scattering signals from observation targets scattered in a three-dimensional space is limited to the vicinity of a single focal plane of the objective lens.

Of course, it is possible to acquire an image of an observation target by changing the focal plane through vertical movement of the objective lens or the sample stage. The depth of focus of a general high-magnification and high-numerical aperture objective lens is in the range of micrometers. In order to produce a clear, focused image, the focal plane needs to be changed with nanometer precision. A moving device used to precisely change the focal plane generally employs a piezoelectric element as an actuator to ensure nanometer-level high-precision transfer. However, such a piezoelectric element has a drawback of very low actuation speed. In addition, since oil is used as a medium for refractive index matching between a sample surface and the objective lens such that high-numerical aperture objective lenses can collect more light, agitation of the observation target can be induced by movement of the objective lens or the sample stage, causing deterioration in image quality and change in reference field.

Therefore, there is an urgent need for a solution to such problems of conventional interferometric scattering microscopy.

### SUMMARY OF THE INVENTION

Embodiments of the present invention have been conceived to solve these problems in the art and it is one aspect of the present invention to provide an interferometric scattering microscope which includes a remote refocusing system adapted to reproduce light collected by a high numerical aperture objective lens using another objective lens and thus can acquire an image of an object in a sample without vertical movement of the objective lens or the sample.

In accordance with one aspect of the present invention, an interferometric scattering microscope includes: a sample holder on which a sample is placed; a light source emitting incident light falling on the sample; a first objective lens transmitting the incident light emitted from the light source to the sample while collecting output light including light reflected by an interface between the sample holder and the sample and light scattered by the sample; a first telecentric lens focusing the output light collected by the first objective lens; a second objective lens transmitting the output light focused by the first telecentric lens into a focal space; a movable mirror disposed in the focal space of the second objective lens to reflect the transmitted output light toward the second objective lens, the movable mirror being movable along an optical axis of the output light; a first tube lens focusing the output light reflected by the movable mirror and having been collected by the second objective lens; and a first detector detecting the output light focused by the first tube lens.

The interferometric scattering microscope may further include: an acousto-optic deflector deflecting the incident light emitted from the light source; a second telecentric lens focusing the incident light deflected by the acousto-optic deflector onto a back focal plane of the first objective lens; a first polarized beam splitter transmitting horizontally polarized light parallel to a plane of incidence while reflecting vertically polarized light perpendicular to the plane of incidence, the horizontally polarized light being the incident light directed to the first objective lens, the vertically polarized light being the output light collected by the first objective lens; and a first quarter-wave plate disposed on a first optical path between the first polarized beam splitter and the first objective lens, along which the incident light and the output light travel, wherein the incident light transmitted and rotated by 90 degrees through the first quarter-wave plate and having been focused onto the back focal plane of the first objective lens scans a two-dimensional plane of the sample at a predetermined deflection angle through the first objective lens, and the output light transmitted and rotated by 90 degrees through the first quarter-wave plate and having been reflected by the first polarized beam splitter passes through the first telecentric lens and is focused onto a back focal plane of the second objective lens.

The interferometric scattering microscope may further include: a half-wave plate disposed on a second optical path between the first telecentric lens and the second objective lens along the optical axis of the output light; a second polarized beam splitter disposed between the half-wave plate and the second objective lens on the second optical path and transmitting the horizontally polarized light while reflecting the vertically polarized light; and a second quarter-wave plate disposed between the second polarized beam splitter and the second objective lens on the second optical path, wherein the output light reflected by the movable mirror travels along the second optical path and is reflected by the second polarized beam splitter to be incident on the first tube lens.

The first telecentric lens may include: a first condensing lens; and a second condensing lens facing the first condensing lens.

The light source may be a laser.

The first detector may include: an image sensor detecting the output light and converting the detected output light into an electrical image signal.

The interferometric scattering microscope may further include: a dichroic mirror reflecting a first type of output light among the output light collected by the first objective lens toward the first quarter-wave plate while transmitting a second type of output light among the output light collected by the first objective lens, the first type of output light having the same wavelength as the incident light, the second type of output light having a different wavelength from the incident light.

The interferometric scattering microscope may further include: a second detector detecting the second type of output light transmitted through the dichroic mirror.

The second detector may be an electron-multiplying CCD camera.

Features and advantages of the present invention will become apparent from the detailed description of the following embodiments in conjunction with the accompanying drawings.

It should be understood that terms or words used in this specification and claims have to be interpreted as having a meaning and concept adaptive to the technical idea of the present invention rather than typical or dictionary interpretation on a principle that an inventor is allowed to properly define the concept of the terms in order to explain their own invention in the best way.

The interferometric scattering microscope according to the present invention can perform interferometric scattering microscopy under an environment in which a coherent reference field is maintained while achieving fast acquisition of a focused image of an object moving in a sample, as compared with a conventional interferometric scattering microscope.

In addition, even when a certain particle is located higher than a complex structure such as a cell, making it impossible to acquire a clear focused image of the particle, the interferometric scattering microscope according to the present invention can ensure fast and easy acquisition of a focused image of the particle using the remote refocusing system. In particular, the interferometric scattering microscope according to the present invention does not cause any disturbance to the sample through elimination of the need to move the objective lens or the sample stage and thus can be very useful in applications requiring a measurement sensitive to external vibration.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 and FIG. 2 are diagrams of an interferometric scattering microscope according to one embodiment of the present invention;

FIG. 3 is a view illustrating the principle of a remote refocusing system shown in FIG. 1;

FIG. 4 is a diagram of an interferometric scattering microscope according to another embodiment of the present invention;

FIG. 5 is a diagram of an interferometric scattering microscope fabricated in an experimental example; and

FIG. 6(a) is an image obtained by stacking a series of images of a central portion of particles acquired by the interferometric scattering microscope of FIG. 5 by sequentially moving a sample stage, FIG. 6(b) is an image obtained by stacking a series of images of the central portion of the particles acquired by the interferometric scattering microscope by sequentially moving a mirror, FIG. 6(c) is a graph showing changes in image intensity on the center line (in red and orange) of the image of FIG. 6(a), FIG. 6(d) is a graph showing changes in image intensity on the center line (in red and orange) of the image of FIG. 6(b), and FIG. 6(e) is a graph showing a relation between the clearest particle image and position values of the sample stage and the mirror.

### DETAILED DESCRIPTION OF THE INVENTION

The above and other aspects, features, and advantages of the present invention will become apparent from the detailed description of the following embodiments in conjunction with the accompanying drawings. It should be noted that like components are denoted by like reference numerals throughout the specification. It will be understood that, although the terms “first”, “second”, and the like may be used herein to describe various elements, components, regions, layers and/or sections, these elements, components, regions, layers and/or sections should not be limited by these terms. These terms are only used to distinguish one element, component, region, layer or section from another element, component, region, layer or section. Descriptions of known functions and constructions which may unnecessarily obscure the subject matter of the present invention will be omitted.

Hereinafter, exemplary embodiments of the present invention will be described in detail with reference to the accompanying drawings.

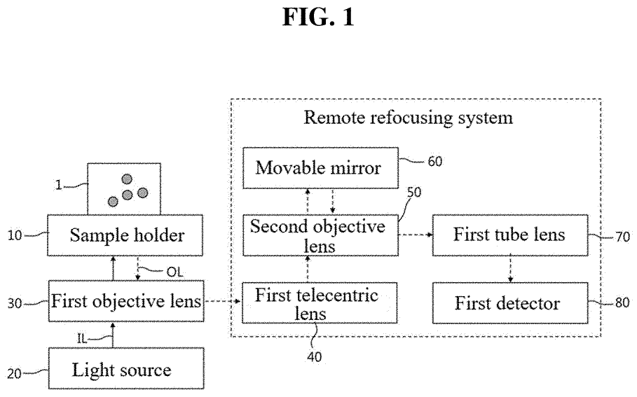

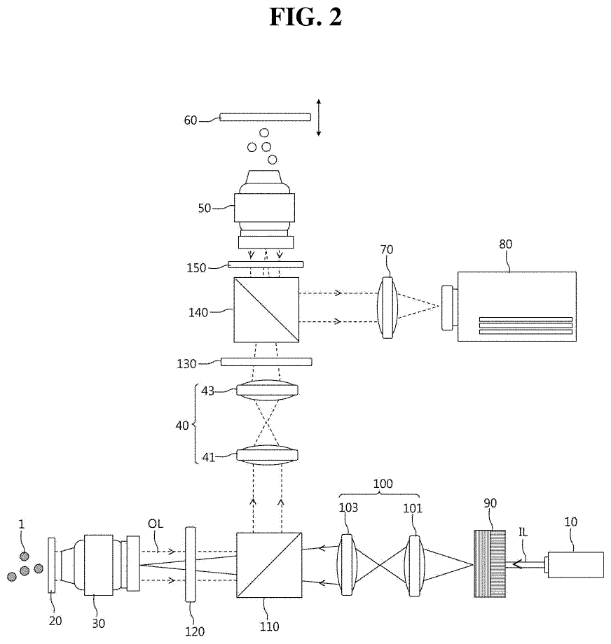

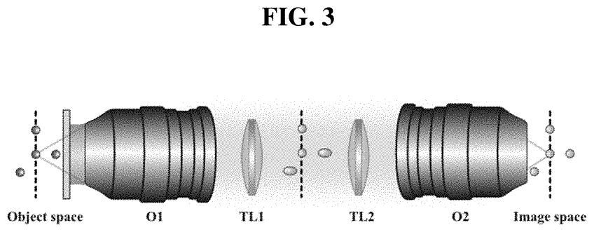

FIG. 1 and FIG. 2 are diagrams of an interferometric scattering microscope according to one embodiment of the present invention, and FIG. 3 is a view illustrating the principle of a remote refocusing system shown in FIG. 1.

Referring to FIG. 1 and FIG. 2, the interferometric scattering microscope according to this embodiment of the present invention includes: a sample holder 10 on which a sample 1 is placed; a light source 20 emitting incident light IL falling on the sample 1; a first objective lens 30 transmitting the incident light IL emitted from the light source 20 to the sample 1 and collecting output light OL including light reflected by an interface between the sample holder 10 and the sample 1 and light scattered from the sample 1; a first telecentric lens 40 focusing the output light OL collected by the first objective lens 30; a second objective lens 50 transmitting the output light OL focused by the first telecentric lens 40 into a focal space; a movable mirror 60 disposed in the focal space of the second objective lens 50 to reflect the transmitted output light OL toward the second objective lens 50, the movable mirror being movable along an optical axis of the output light OL; a first tube lens 70 focusing the output light OL reflected by the movable mirror 60 and having been collected by the second objective lens 50; and a first detector 80 detecting the output light OL focused by the first tube lens 70.

The present invention relates to an interferometric scattering microscope. The interferometric scattering microscope detects and images an observation target (object) dispersed in a sample 1 using interference light generated by interference between light scattered from the observation target and light reflected by an interface between the sample 1 and a sample holder 10 with the sample 1 placed thereon. Conventional interferometric scattering microscopy acquires a focused image of an observation target by vertically moving an objective lens or a sample stage with a sample holder mounted thereon. In order to produce a clear, focused image, focal plane positioning through vertical movement of the objective lens or the sample stage needs to be performed with high precision. A piezoelectric element is generally used as an actuating means for precise focal plane positioning. However, the piezoelectric element has a drawback of very low actuation speed. In addition, since conventional interferometric scattering microscopy uses oil as a medium for refractive index matching between a sample surface and an objective lens such that high-numerical aperture objective lenses can collect more reflected light and scattered light, agitation of an observation target and change in reflection from the observation target can be induced by vertical movement of the objective lens or the sample stage, making it impossible to achieve fast acquisition of a clear, focused image. The present invention has been conceived to solve these problems of conventional interferometric scattering microscopy.

As described above, the interferometric scattering microscope according to the embodiment of the present invention includes the sample holder 10, the light source 20, the first objective lens 30, the first telecentric lens 40, the second objective lens 50, the movable mirror 60, the first tube lens 70, and the first detector 80.

The sample holder 10 holds the sample 1. Here, the sample 1 contacts a surface of the sample holder 10. Accordingly, an interface is formed between the sample 1 and the sample holder 10. The sample 1 contains an observation target (object) to be imaged. The sample 1 may be in a liquid or solid phase. Although the sample holder 10 may be a sample chamber or a glass substrate, it will be understood that the present invention is not limited thereto and the sample holder 10 may be any type of holder that can hold the sample 1. For example, the sample holder 10 may be a glass substrate and the sample 1 may be a liquid sample 1 dispensed on the glass substrate. The sample holder 10 may be mounted on a sample stage.

The light source 20 is a light emitting device and emits incident light IL falling on the sample 1. The light source 20 may be a laser.

The first objective lens 30 transmits the incident light IL from the light source 20 to the sample 1 and collects output light OL. The output light OL includes reflected light and scattered light. Here, the reflected light is a portion of the incident light IL falling on the sample 1, which is reflected by the interface between the sample holder 10 and the sample 1, and the scattered light is the other portion of the incident light IL, which is scattered by the sample 1, that is, the observation target. The reflected light and the scattered light generate interference light through interference with each other. The output light OL collected by the first objective lens 30 produces an image of the observation target through a remote refocusing system.

The remote refocusing system includes the first telecentric lens 40, the second objective lens 50, the movable mirror 60, the first tube lens 70, and the first detector 80.

The remote refocusing system is a technology that acquires an image of an observation target without focal plane positioning through vertical movement of an objective lens or a sample (the observation target), and the principle thereof will be described with reference to FIG. 3.

The remote refocusing system reproduces all light components collected by a high-numerical aperture objective lens O1 using another objective lens O2. Light originating from particles present in an object space is collected by the objective lens O1 and then forms an image on a focal plane of a tube lens TL1. Since the tube lens TL1 generally has a smaller numerical aperture than the objective lens O1, an image of a particle located out of the focal plane suffers from distortion due to optical aberration. This phenomenon occurs because image reproducibility of the tube lens TL1 is much lower than that of the objective lens O1. However, aberration occurring in the tube lens TL1 can be compensated by allowing all the light components having passed through the tube lens TL1 to be focused into an image through the high-numerical aperture objective lens O2, whereby an aberration-free image can be formed in an image space of the objective lens O2.

Here, the first telecentric lens 40 focuses the output light OL collected by the first objective lens 30. For example, the first telecentric lens 40 may include a first condensing lens 41 and a second condensing lens 43 facing each other.

The second objective lens 50 transmits the output light OL focused by the first telecentric lens 40 into the focal space. Here, the output light OL is re-imaged by the second objective lens 50, whereby an aberration-free image is reproduced in the focal space.

The movable mirror 60 is disposed in the focal space of the second objective lens 50 to reflect the output light OL transmitted into the focal space back to the second objective lens 50. Here, the movable mirror 60 is movable along the optical axis of the output light OL.

The first tube lens 70 focuses the output light OL reflected by the movable mirror 60 and having been transmitted through the second objective lens 50.

The output light OL focused by the first tube lens 70 is projected onto the first detector 80. The first detector 80 images the observation target in the sample 1 through detection of the output light OL. The first detector 80 may include an image sensor that detects the output light OL and converts the detected output light into an electrical image signal. The image sensor may be, for example, a CMOS image sensor without being limited thereto.

Here, through movement of the movable mirror 60, it is possible to acquire an aberration-free image of the observation target reproduced in the focal space of the second objective lens 50.

The interferometric scattering microscope according to the embodiment of the present invention may further include an acousto-optic deflector 90, a second telecentric lens 100, a first polarized beam splitter 110, and a first quarter-wave plate 120.

The acousto-optic deflector (AOD) 90 deflects the incident light IL emitted from the light source 20.

The second telecentric lens 100 focuses the incident light IL deflected by the acousto-optic deflector 90 onto a back focal plane of the first objective lens 30. The second telecentric lens 100 may include a first condensing lens 101 and a second condensing lens 103 facing each other.

The first polarized beam splitter (PBS) 110 is an optical device that transmits horizontally polarized light parallel to a plane of incidence and reflects vertically polarized light perpendicular to the plane of incidence. The first polarized beam splitter 110 is disposed on a first optical path along which the incident light IL and the output light OL travel. Accordingly, the incident light IL deflected by the acousto-optic deflector 90 and having passed through the second telecentric lens 100 is transmitted through the first polarized beam splitter 110 and travels to the first objective lens 30 along the first optical path. In addition, the output light OL collected by the first objective lens 30 travels to the first polarized beam splitter 110 along the first optical path and is reflected by the first polarized beam splitter 110.

The first quarter-wave plate (QWP) 120 is disposed between the first polarized beam splitter 110 and the first objective lens 30 on the first optical path. Accordingly, a horizontally polarized component of the incident light IL transmitted through the first polarized beam splitter 110 and traveling to the first objective lens 30 is converted into circularly polarized light through the first quarter-wave plate 120. In addition, the output light OL collected by the first objective lens 30 is converted into vertically polarized light through the first quarter-wave plate 120 to be reflected by the first polarized beam splitter 110.

The incident light IL transmitted through the first quarter-wave plate 120 and having been focused onto the back focal plane of the first objective lens 30 scans a two-dimensional plane of the sample 1 at a predetermined deflection angle through the first objective lens 30. In addition, the output light OL transmitted through the first quarter-wave plate 120 and having been reflected by the first polarized beam splitter 110 is transmitted through the first telecentric lens 40 to be focused onto a back focal plane of the second objective lens 50. In this way, an aberration-free image of the observation target can be produced through the remote refocusing system.

In addition, the remote refocusing system of the interferometric scattering microscope according to the embodiment of the present invention may further include a half-wave plate 130, a second polarized beam splitter 140, and a second quarter-wave plate 150.

The half-wave plate (HWP) 130 may be disposed on a second optical path between the first telecentric lens 40 and the second objective lens 50 along the optical axis of the output light OL. Accordingly, the output light OL converted into vertically polarized light through the first quarter-wave plate 120, reflected by the first polarized beam splitter 110, and having been transmitted through the first telecentric lens 40 is converted into horizontally polarized light through the half-wave plate 130.

The second polarized beam splitter (PBS) 140 is an optical device that transmits horizontally polarized light parallel to a plane of incidence and reflects vertically polarized light perpendicular to the plane of incidence, and is disposed between the half-wave plate 130 and the second objective lens 50 on the second optical path. Accordingly, the output light OL transmitted through the first telecentric lens 40 and having been converted into horizontally polarized light by the half-wave plate 130 is transmitted through the second polarized beam splitter 140.

The second quarter-wave plate (QWP) 150 is disposed between the second polarized beam splitter 140 and the second objective lens 50 on the second optical path. Accordingly, the horizontally polarized output light OL transmitted through the second polarized beam splitter 140 is converted into circularly polarized light through the second quarter-wave plate 150 and is focused onto the back focal plane of the second objective lens 50. In addition, the output light OL transmitted through the second objective lens 50 and having been reflected by the movable mirror 60 is transmitted through the second objective lens 50 and is converted into vertically polarized light through the second quarter-wave plate 150. Accordingly, the output light OL converted into vertically polarized light and travelling along the second optical path is reflected by the second polarized beam splitter 140 onto the first tube lens 70 and is projected onto the first detector 80. In this way, only the output light OL reflected by the movable mirror 60 can be projected onto the first detector 80 through the second polarized beam splitter 140 and the second quarter-wave plate 150.

In conclusion, with the remote refocusing system, the interferometric scattering microscope according to the present invention can acquire an aberration-free image of the observation target reproduced in the focal space of the second objective lens through movement of the movable mirror along the optical axis of the output light without moving the objective lens or the sample stage (the observation target). In addition, the interferometric scattering microscope according to the present invention can perform interferometric scattering microscopy under an environment in which a coherent reference field is maintained while achieving fast acquisition of a focused image of the object moving in the sample, as compared with conventional interferometric scattering microscopes. Further, even when a certain particle is located higher than a complex structure such as a cell, making it impossible to acquire a clear, focused image of the particle, the interferometric scattering microscope according to the present invention can ensure fast and easy acquisition of a focused image of the particle using the remote refocusing system. In particular, the interferometric scattering microscope according to the present invention does not cause any disturbance to the sample through elimination of the need to move the objective lens or the sample stage and thus can be very useful in applications requiring a measurement sensitive to external vibration.

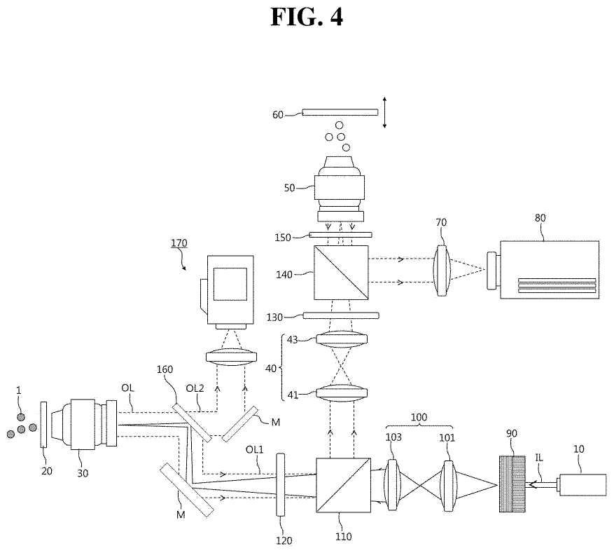

FIG. 4 is a diagram of an interferometric scattering microscope according to another embodiment of the present invention.

Referring to FIG. 4, the interferometric scattering microscope according to this embodiment may further include a dichroic mirror 160 besides the components of the interferometric scattering microscope described above with reference to FIG. 1 and FIG. 2.

The dichroic mirror (DM) 160 is a filter that reflects light in a specific wavelength range while transmitting light in other wavelength ranges, and reflects a first type of output light OL1, which is a portion of the output light OL collected by the first objective lens 30, and transmits a second type of output light OL2, which is the other portion of the output light OL collected by the first objective lens 30. Here, the first type of output light OL1 may be output light OL having the same wavelength as the incident light IL falling on the sample 1, and the second type of output light OL2 may be output light OL having a different wavelength from the incident light IL. Here, the second type of output light OL2 may have a longer wavelength than the incident light IL. The first type of output light OL1 reflected by the dichroic mirror 160 travels toward the first quarter-wave plate 120. Here, the incident light IL having passed through the first quarter-wave plate 120 may be reflected by a mirror M and then reflected again by the dichroic mirror 160 to be focused onto the back focal plane of the first objective lens 30, and the first type of output light OL1 may be reflected again by the mirror M and then pass through the first quarter-wave plate 120.

In addition, the interferometric scattering microscope according to this embodiment may further include a second detector 170.

The second detector 170 detects the second type of output light OL2 transmitted through the dichroic mirror 160. For example, the second detector 170 may be an electron-multiplying CCD (EMCCD) camera. The second type of output light OL2 may form a focused image on the EMCCD camera. The EMCCD camera may be used to measure fluorescence emission generated by the second type of output light OL2. Although a mirror M may be used to redirect the second type of output light OL2 having passed through the dichroic mirror 160, it will be understood that using the mirror M is not the only way to redirect the second type of output light OL2.

Next, the present invention will be described in more detail with reference to an experimental example.

1. Fabrication of Interferometric Scattering Microscope

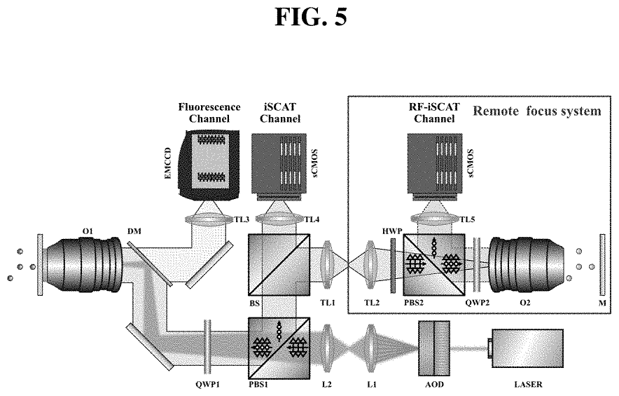

FIG. 5 is a diagram of an interferometric scattering microscope fabricated in an experimental example. The interferometric scattering microscope was fabricated as shown in FIG. 5.

Light emitted from a laser is deflected by an acousto-optic deflector (AOD) and then is focused onto a back focal plane of an objective lens O1 by a telecentric lens L1, L2. Here, a horizontally polarized component ( [symbol] ) of the light traveling toward the objective lens O1 is converted into circularly polarized light through a polarized beam splitter PBS1 and a quarter-wave plate QWP1. The light focused onto the back focal plane of the objective lens O1 scans a two-dimensional plane of a sample at a predetermined deflection angle with respect to an optical axis thereof. Reflected light and scattered light from the sample are recollected by the objective lens O1. Here, light components of the reflected light and the scattered light having a longer wavelength than incident light pass through a dichroic mirror DM and then form a focused image on an electron-multiplying CCD (EMCCD) camera. In addition, light components of the reflected light and the scattered light having the same wavelength as the incident light are converted into vertically polarized light (o) through the quarter-wave plate QWP1 to be reflected by the polarized beam splitter PBS1. Then, the light reflected by the quarter-wave plate QWP1 is split into two halves (50:50) through a beam splitter BS. One of the two halves passes through a tube lens TL4 and then is projected onto a scientific CMOS (sCMOS) camera of an iSCAT channel and the other half travels toward a remote refocusing system. The light traveling to the remote refocusing system is focused onto a back focal plane of an objective lens O2 by a telecentric lens TL1, TL2. The focused light is re-imaged by the objective lens O2, whereby an aberration-free image is reproduced in a focal space of the objective lens O2. The light in the focal space of the objective lens O2 is reflected by a mirror M and then is projected onto an sCMOS camera of an RF-iSCAT channel through a tube lens TL5. Through movement of the mirror M along the optical axis of the light, it is possible to acquire an aberration-free image of particles reproduced in the focal space of the objective lens O2. In addition, in the remote refocusing system, a half-wave plate HWP is used to convert a vertically polarized reference field and reflected field (o) into horizontally polarized light ( [symbol] ) and a polarized beam splitter PBS2 and a quarter-wave plate QWP2 are used to project only the light reflected by the mirror M onto the sCMOS camera.

2. Analysis of Characteristics of Interferometric Scattering Microscope

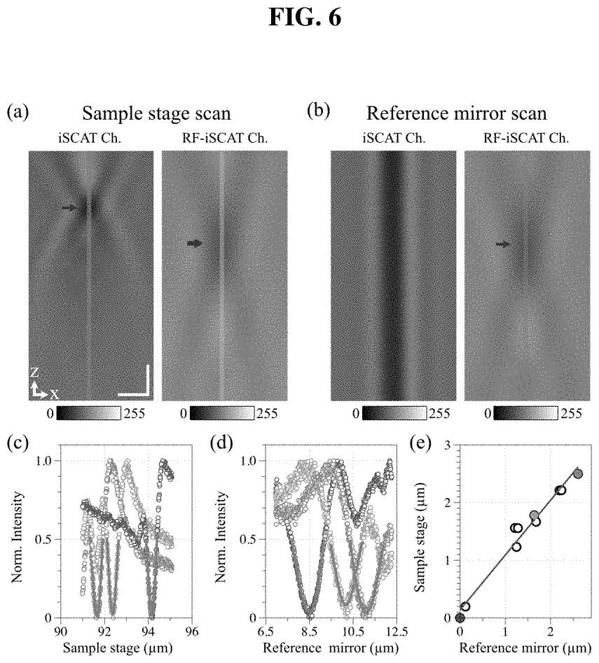

In order to identify characteristics of the interferometric scattering microscope using the remote refocusing system, changes in intensity of particle images acquired by moving the sample stage and the mirror M along the optical axis were measured in each of the iSCAT and RF-iSCAT channels and then compared with each other. Results are shown in FIG. 6. 0.2 μm diameter polystyrene particles were used as an experimental sample. Here, the particles were randomly distributed in an about 5 μm thick cured PDMS layer.

FIG. 6(a) is an image obtained by stacking a series of images of a central portion of the particles acquired by the interferometric scattering microscope of FIG. 5 by sequentially moving the sample stage, FIG. 6(b) is an image obtained by stacking a series of images of the central portion of the particles acquired by the interferometric scattering microscope by sequentially moving the mirror, FIG. 6(c) is a graph showing changes in image intensity on the center line (in red and orange) of the image of FIG. 6(a), FIG. 6(d) is a graph showing changes in image intensity on the center line (in red and orange) of the image of FIG. 6(b), and FIG. 6(e) is a graph showing a relation between the clearest particle image and position values of the sample stage and the mirror.

FIG. 6(a) shows intensity changes between focused images of a cross-section of the particles acquired by vertically moving the sample stage, wherein intensity changes between images collected by the objective lens O1 were reflected in both the iSCAT channel and the RF-iSCAT channel. Conversely, referring to FIG. 6(b), which was obtained by moving the mirror M of the remote refocusing system with the sample stage being stationary, intensity changes occurred only between images acquired in the RF-iSCAT channel. Such intensity changes were identical to those occurring between images acquired in the RF-iSCAT channel of FIG. 6(a).

In order to identify changes in image intensity according to changes in position of the sample stage and the mirror, it was determined how the intensity of images of the central portion of the particles acquired in the iSCAT channel of FIG. 6(a) and the RF-iSCAT channel of FIG. 6(b) changes as the axial position of the sample stage and the mirror changes. FIG. 6(c) and FIG. 6(d) show intensity changes occurring in images of three particles at different heights acquired in the iSCAT channel and the RF-iSCAT channel with changing axial position of the sample stage or the mirror. All intensity changes were normalized in the range of 0 to 1. A normalized intensity of 0 indicates that the sample stage or the mirror is located at a position allowing formation of a focused image of the particles. Here, in order to clearly describe each of such positions, intensity values were approximated by a fourth-order polynomial function around points at which the normalized intensity is equal to 0, and a point at which the polynomial function has a slope of 0 was defined as the position of the sample stage or the mirror allowing formation of a focused image of the particles. Position values of the sample stage and the mirror with respect to all observed particles were plotted on the graph of FIG. 6(e) and were approximated by a first-order linear function. When a position value of a focused image of the particles acquired in the RF-iSCAT channel is put into the relation found in this way, it is possible to find a position value of the sample stage corresponding to a focused image of the particles anticipated to be acquired in the iSCAT channel. That is, intensity change between focused images of the particles acquired by axially moving the sample stage is a result of physical movement. Accordingly, the vertical position of the particles in the sample can be measured based on the vertical position value of the sample stage, and the graph of FIG. 6(e) allows predicting the result of movement of the sample stage based on the result of movement of the mirror.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention.

Therefore, the scope of the present invention should be defined by the following appended claims as covering such modifications or variations derived from the appended claims and equivalents thereto.

What is claimed is:

1. An interferometric scattering microscope comprising:
a sample holder on which a sample is placed;
a light source emitting incident light falling on the sample;
a first objective lens transmitting the incident light emitted from the light source to the sample while collecting output light comprising light reflected by an interface between the sample holder and the sample and light scattered by the sample;
a first telecentric lens focusing the output light collected by the first objective lens;
a second objective lens transmitting the output light focused by the first telecentric lens into a focal space;
a movable mirror disposed in the focal space of the second objective lens to reflect the transmitted output light toward the second objective lens, the movable mirror being movable along an optical axis of the output light;
a first tube lens focusing the output light reflected by the movable mirror and having been collected by the second objective lens; and
a first detector detecting the output light focused by the first tube lens.

2. The interferometric scattering microscope according to claim 1, further comprising:
an acousto-optic deflector deflecting the incident light emitted from the light source;
a second telecentric lens focusing the incident light deflected by the acousto-optic deflector onto a back focal plane of the first objective lens;
a first polarized beam splitter transmitting horizontally polarized light parallel to a plane of incidence while reflecting vertically polarized light perpendicular to the plane of incidence, the horizontally polarized light being the incident light polarized through the second telecentric lens, the vertically polarized light being the output light collected by the first objective lens; and
a first quarter-wave plate disposed on a first optical path between the first polarized beam splitter and the first objective lens, along which the incident light and the output light travel,
wherein the incident light transmitted through the first quarter-wave plate and having been focused onto the back focal plane of the first objective lens scans a two-dimensional plane of the sample at a predetermined deflection angle through the first objective lens, and
the output light transmitted through the first quarter-wave plate and having been reflected by the first polarized beam splitter passes through the first telecentric lens and is focused onto a back focal plane of the second objective lens.

3. The interferometric scattering microscope according to claim 2, further comprising:
a half-wave plate disposed on a second optical path between the first telecentric lens and the second objective lens along the optical axis of the output light;
a second polarized beam splitter disposed between the half-wave plate and the second objective lens on the second optical path and transmitting the horizontally polarized light while reflecting the vertically polarized light; and
a second quarter-wave plate disposed between the second polarized beam splitter and the second objective lens on the second optical path,
wherein the output light reflected by the movable mirror travels along the second optical path and is reflected by the second polarized beam splitter to be incident on the first tube lens.

4. The interferometric scattering microscope according to claim 1, wherein the first telecentric lens comprises: a first condensing lens; and a second condensing lens facing the first condensing lens.

5. The interferometric scattering microscope according to claim 1, wherein the light source is a laser.

6. The interferometric scattering microscope according to claim 1, wherein the first detector comprises: an image sensor detecting the output light and converting the detected output light into an electrical image signal.

7. The interferometric scattering microscope according to claim 2, further comprising:
a dichroic mirror reflecting a first type of output light among the output light collected by the first objective lens toward the first quarter-wave plate while transmitting a second type of output light among the output light collected by the first objective lens, the first type of output light having the same wavelength as the incident light, the second type of output light having a different wavelength from the incident light.

8. The interferometric scattering microscope according to claim 7, further comprising:
a second detector detecting the second type of output light transmitted through the dichroic mirror.

9. The interferometric scattering microscope according to claim 8, wherein the second detector is an electron-multiplying CCD camera.
